(19) United States
(12) Patent Application Publication
(10) Pub. No.: US 2014/0293034 A1
(43) Pub. Date: Oct. 2, 2014

(54) IMAGING DEVICE

(71) Applicant: Masao Yamamoto, Tokyo (JP)

(72) Inventor: Masao Yamamoto, Tokyo (JP)

(73) Assignee: SCALAR CORPORATION, Tokyo (JP)

(21) Appl. No.: 14/233,421

(22) PCT Filed: Jul. 18, 2012
(86) PCT No.: PCT/JP2012/068236

§ 371 Date: Mar. 21, 2014

(30) Foreign Application Priority Data
Jul. 19, 2011 (JP) 2011-157869

(51) Int. Cl. G02B 21/36

(52) U.S. Cl. CPC G02B 21/361
USPC 348/79

(57) ABSTRACT

Provided is a technique that makes it possible to inexpensively image a miniscule target located inside or on the surface of a light-transmitting substrate. An imaging device (100) is provided with the following on opposite sides of the substrate (60): a hole (34) that functions as a point light source; and an imaging element (53) that performs the imaging. Light from the hole (34) reaches the imaging plane (53A) of the imaging element (53) at a magnification of L2/L1, allowing magnified imaging without a lens.

### TECHNICAL FIELD

The present invention relates to a technique to take an image of a small subject present on or in the surface of a substrate that allows light to pass through.

### BACKGROUND ART

There are demands on a technique to take an image of a small subject present on or in the surface of a substrate that allows light to pass through.

For example, such demands are found in biosensor techniques disclosed in Japanese Patent Laid-Open Nos. 2008-128677 and 2009-115590.

For reference, these biosensor techniques are as follows.

With these biosensor techniques, in order to detect a biomaterial to be detected (such as antigen; hereinafter, description is made for a case where the biomaterial is antigen for the purpose of simplicity), magnetic nanoparticles with a size on the order of nanometers to which antibody against the antigen being detected is bound are introduced into a solution suspected to contain the antigen of interest, and the mixture is stirred. If antigen is present in the solution, this antigen is bound to the antibody already bound to the magnetic nanoparticles by the antibody-antigen reaction.

Next, the solution containing the magnetic nanoparticles to which the antigen is bound through the antibody is applied to a substrate to which antibody is bound at arbitrary position. Then, the antigen bound to the magnetic nanoparticles through the antibody is bound to the antibody on the substrate by the antibody-antigen reaction. The magnetic nanoparticles are anchored to the substrate in the order of the substrate, the antibody, the antigen, the antibody, and the magnetic nanoparticle.

Subsequently, the solution containing magnetic microparticles with a size on the order of micrometers is applied to the substrate, and a magnetic field is produced across the substrate. In many cases, two or more magnetic microparticles are attracted to the magnetic nanoparticles by the magnetic force. When the position on the substrate at which the antibody is bound is known previously, it can be considered that the antigen of interest is contained in the aforementioned solution suspected to contain that antigen if two or more magnetic microparticles are present at that position.

In these techniques, whether or not the magnetic microparticles are present at the site on the substrate to which the antibody is bound can be determined by using optical imaging. It is not difficult in a technical sense to take an image of a subject on a micrometer scale by using a microscope.

### SUMMARY OF THE INVENTION

### Problems to be Solved by the Invention

Microscopes used to take an image of a subject on a micrometer scale are relatively costly, and often priced at several million yens. It is thus difficult to expand the biosensor techniques broadly.

There are demands on a technique which is not limited to those described above to take an image of a small subject present on or in the surface of a substrate that allows light to pass through, but no process is known to achieve this in a non-expensive manner.

An object of the present invention is to provide a technique with which an image of a small subject present on or in the surface of a substrate that allows light to pass through can be taken at a reasonable cost.

### Means to Solve the Problems

In order to solve the aforementioned problem, the present inventor proposes the following inventions.

The present invention can generally be divided into two inventions. Description is made with these two inventions referred to as a first invention and a second invention.

The first invention is an imaging device for taking an image of a small subject present on or in the surface of a substrate that allows light to pass through, comprising: a light source to produce illumination light and an imaging element which is an element to take an image, the light source and the imaging element being opposed to each other across the substrate, the light source being a point light source, and the imaging element having an imaging plane where a number of pixels are arranged, the imaging plane being faced to the substrate.

The imaging device of the first invention is novel in that neither a lens nor a reflective mirror is provided both of which are typically used between the substrate and the imaging element to magnify imaging light. However, the illumination light from the light source which is the point light source is magnified in the course of its passing through the substrate before reaching the imaging element, so that an optically enlarged image of the subject is thrown on the imaging element of the first invention.

In addition, the imaging device of the first invention does not use a lens, has a very small NA, and has a large focal depth. This contributes to taking a focused image of the subject even when the substrate has a certain degree of thickness, or regardless of where the subject is present between the proximal end of the substrate closer to the imaging device and the distal end thereof, or even when the distance between the substrate and the imaging element is changed slightly.

The reason why the point light source is used as the light source lies in the purpose of clarifying, as much as possible, the contour of the image of the subject formed on the imaging plane of the imaging element. Note that it is substantially impossible to achieve a point light source with no area as the light source, no matter how it may be theoretically. A substantial point light source that can be achieved by a pinhole is enough for the point light source as used in the present specification.

The distance between the light source and the substrate, and the distance between the substrate and the imaging element can be any distance. Let the distance between the light source and the substrate be L1, and the distance between the light source and the imaging element be L2, the optical magnification is then given as L2/L1. Accordingly, the positions of the light source, the substrate, and the imaging element are determined so that a desired magnification can be obtained.

In addition, the imaging element may be placed away from the substrate, so that an image of the subject whose image is to be taken, on the imaging plane is larger than the size of the pixel. When the image of the subject thrown on the imaging plane is smaller than the pixel on the imaging plane of the imaging element, it becomes difficult to capture the shape of the image of the subject using the imaging element. In order to capture the image of the subject using the imaging element, it is better that the image of the subject thrown on the imaging plane extends over two or more pixels. Using the aforementioned conditions can satisfy the condition where the image of the subject thrown on the imaging plane extends over two or more pixels is satisfied. It is better that the image of the subject thrown on the imaging plane extends over two or more pixels, but it would become easier to recognize the shape of the image when it extends over, for example, 9 (3 by 3) pixels.

Provided that the imaging device of the present application is used as a device for detecting the “presence” or the “absence” of the subject, the image of the subject thrown on the imaging plane does not necessarily extend over two or more pixels. The presence or absence of the subject can be detected only based on whether or not a single pixel captures the image.

The imaging device of the first invention may comprise supporting means to position and support the substrate at a predetermined position between the light source and the imaging element. Such supporting means allows reproducible provision of the aforementioned optical magnification defined by L2/L1 with a desired value or allows projection of the image of the subject over two or more pixels of the imaging plane.

When the supporting means is present, the relative positions of the supporting means, the light source, and the imaging element can be varied. For example, the light source and the imaging element may be configured so that it can move relative to the substrate that is firmly supported. Alternatively, the position of the substrate may be determined flexibly between the secured light source and the secured imaging element, or the light source, the substrate, and the imaging element may be configured so that their positions can be changed. In any case, even when the subjects whose image is to be taken are different in size from each other, it becomes possible to provide the aforementioned optical magnification defined by L2/L1 with a desired value in a reproducible manner, or to project the image of the subject over two or more pixels of the imaging plane.

The supporting means does not necessarily hold the substrate. Instead, it may merely carry the substrate mounted thereon.

The present inventor also proposes a method having same effects to those obtained using the imaging device of the first invention.

An example of this method is an imaging method for taking an image of a small subject present on or in the surface of a substrate that allows light to pass through, comprising the steps of: positioning the substrate, a light source which is a point light source to produce illumination light, and an imaging element which is an element to take an image, the imaging element having an imaging plane where a number of pixels are arranged, in such a manner that the light source and the imaging element are opposed to each other across the substrate and that the imaging plane is faced to the substrate; and directing the illumination light from the light source to the imaging element.

The second invention proposed by the present inventor is as follows.

The second invention is imaging device for taking an image of a small subject present on or in the surface of a substrate that allows light to pass through, comprising: a light source to produce illumination light and an imaging element which is an element to take an image, the light source and the imaging element being opposed to each other across the substrate, the light source being a directional light source which produces parallel rays, and the imaging element having an imaging plane where a number of pixels are arranged, the imaging plane being faced to the substrate.

The imaging device of the second invention is novel in that neither a lens nor a reflective mirror is provided both of which are typically used between the substrate and the imaging element to magnify imaging light, as in the case of the imaging device of the first invention. However, unlike the first invention, the illumination light from the light source which is the directional light source is not magnified in the course of its passing through the substrate before reaching the imaging element, on that no optically enlarged image of the subject is obtained using the imaging element of the imaging device according to the second invention.

In addition, the imaging device of the second invention has a large focal depth for the reasons similar to those in the imaging device of the first invention. This contributes to taking a focused image of the subject even when the substrate has a certain degree of thickness, or regardless of where the subject is present between the proximal end of the substrate closer to the imaging device and the distal end thereof, or even when the distance between the substrate and the imaging element is changed slightly.

The reason why the directional light source is used as the light source in the second invention lies in the purpose of clarifying, as much as possible, the contour of the image of the subject formed on the imaging plane of the imaging element. Note that it is substantially nearly impossible to achieve a complete directional light source as the light source, no matter how it may be theoretically. The directional light source as used in the present specification may be a known directional light source considered to be a directional light source, such as a combination of a point light source and a condenser lens or a combination of a point light source and a Fresnel lens.

The imaging element of the second invention may be configured in such a manner that an image of the subject whose image is to be taken, on the imaging plane is larger than the size of the pixel. By selecting such imaging element, the image of the subject thrown on the imaging plane extends over two or more pixels, which is suitable for capturing the image of the subject using the imaging element. It is better that the image of the subject thrown on the imaging plane extends over two or more pixels, but it would become easier to recognize the shape of the image when it extends over, for example, 9 (3 by 3) pixels.

Provided that the imaging device of the present application is used as a device for detecting the “presence” or the “absence” of the subject, the image of the subject thrown on the imaging plane does not necessarily extend over two or more pixels, as in the case of the first invention.

The imaging device of the second invention may also comprise supporting means to position and support the substrate at a predetermined position between the light source and the imaging element. The supporting means does not necessarily hold the substrate. Instead, it may merely carry the substrate mounted thereon.

In the imaging device of the second invention, similar to the imaging device of the first invention, the relative positions of the supporting means, the light source, and the imaging element can be varied when the supporting means is present. In the second invention, however, the change in these relative positions does not result in adjustment of the optical magnification. Accordingly there is little point in changing the relative positions of the supporting means, the light source, and the imaging element.

The present inventor also proposes a method having same effects to those obtained using the imaging device of the second invention.

An example of this method is an imaging method for taking an image of a small subject present on or in the surface of a substrate that allows light to pass through, comprising the steps of: positioning the substrate, a light source which is a directional light source to produce parallel rays, and an imaging element which is an element to take an image, the imaging element having an imaging plane where a number of pixels are arranged, in such a manner that the light source and the imaging element are opposed to each other across the substrate and that the imaging plane is faced to the substrate; and directing the illumination light from the light source to the imaging element.

### BRIEF DESCRIPTION OF THE DRAWINGS

FIG. 1 is a side view schematically showing a structure of an imaging device according to a first embodiment of the present invention;

FIG. 2 is a plan view showing a structure of a supporting unit of the imaging device shown in FIG. 1;

FIG. 3 is a plan view showing a structure of an imaging unit of the imaging device shown in FIG. 1;

FIG. 4 is a side view schematically showing the motion of illumination light in the imaging device shown in FIG. 1; and

FIG. 5 is a side view schematically showing a structure of an imaging device according to a second embodiment of the present invention.

### MODE FOR CARRYING OUT THE INVENTION

Preferred first and second embodiments of the present invention are described below. Identical or similar components are denoted by the same reference numerals in the description of these embodiments, and redundant description may be omitted,

### First Embodiment

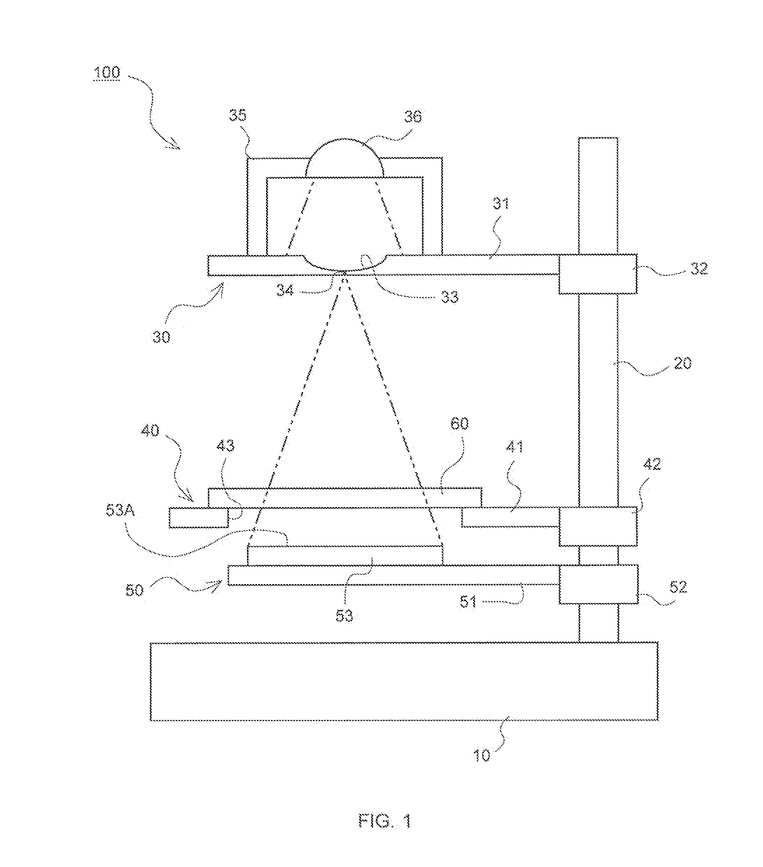

An imaging device 100 according to the first embodiment is schematically shown in FIG. 1. This imaging device 100 is for taking an image of a small subject present on or in the surface of a substrate that allows light to pass through.

The imaging device 100 comprises a base 10 and a post 20.

The base 10 is shaped like a plate to provide stable support for the post 20 and other parts mounted thereon that are described later. The base 10 should have a certain degree of weight. The base 10 is thus made of metal in this embodiment, but which is not necessarily so.

The post 20 is a column which stands upright relative to the base 10 in this embodiment. The post 20 has a long, hollow cylindrical shape, but which is not necessarily so.

An illumination unit 30, a supporting unit 40, and an imaging unit 50 are connected to the post 20 in this order from above. The illumination unit 30, the supporting unit 40, and the imaging unit 50 are mounted on the post 20 via plate members 31, 41, and 51 (each of which is shaped like a plate) and post clamps 32, 42, and 52, respectively.

The post clamps 32, 42, and 52 can move vertically on the post 20 and can be mounted on the post 20 at any position, but which is not necessarily so. The illumination unit 30, the supporting unit 40, and the imaging unit 50 can thus be positioned at any position along the length of the post 20.

Any one of known or well-known techniques may be used to achieve such flexible positioning of the post clamps 32, 42, and 52 along the length of the post 20. For example, the outer surface of the post 20 may be threaded and a nut may be provided with each of the post clamps 32, 42, and 52. In this case, these nuts can be rotated relative to the post clamps 32, 42, and 52, and are thus threaded to the post 20. Alternatively, a magnet may be provided in at least one of the post clamp and the post to magnetically attach the post clamps 32, 42, and 52 to the post 20 at any position.

The aforementioned mechanism may or may not be the same for all of the post clamps 32, 42, and 52.

Although the illumination unit 30, the supporting unit 40, and the imaging unit 50 in this embodiment are all movable along the length of the post 20 as described above, the supporting unit 40 may be secured to the post 20 and only the illumination unit 30 and the imaging unit 50 may be movable along the length of the post 20. Alternatively, the illumination unit 30 and the imaging unit 50 may be secured to the post 20 and only the supporting unit 40 may be movable along the length of the post 20. In this way, one or more of the illumination unit 30, the supporting unit 40, and the imaging unit 50 may be movable along the length of the post 20.

As described above, the illumination unit 30 comprises the plate member 31. The plate member 31 is rectangular, is made of metal, and has a bowl-shaped concave portion 33 at an approximate center thereof, but which is not necessarily so. The thickness of the plate member 31 is very small at the center of the concave portion 33, and a hole 34 having a very small diameter is formed in the plate member 31 at the center of the concave portion 33. The hole 34 is a so-called pinhole and, specifically, has a size of about several micrometers in this embodiment.

A case 35 having a generally rectangular parallelepiped shape is disposed on the plate member 31. The case 35 covers the hole 34 and is made of a material that does not allow light to pass through, i.e., an appropriate metal in this embodiment.

A lighting member 36 is provided in the top of the case 35 in such manner that its optical axis is directed to the hole 34. The lighting member 36 is for irradiating light at a specific wavelength and is turned on and off with a switch which is not shown. The light produced by the lighting member 36 escapes from the case 35 only through the hole 34. As a result, in the illumination unit 30, the hole 34 thereof serves as a substantial point light source. The light produced by the lighting member 36 which is irradiated from the illumination unit 30 through the hole 34 projects the shape of a light-emitting component of the lighting member 36 (e.g., filament when the lighting member 36 is an incandescent lamp or an LED chip when the lighting member 36 is an LED). In order to avoid this, it is better to use a diffuser (such as a frosted glass plate) at an appropriate location between the lighting member 36 and a substrate which is described later.

As apparent from the above, the illumination unit 30 in this embodiment delivers the illumination light from the point light source to the substrate. As long as this can be achieved, the configuration of the illumination unit 30 may be changed.

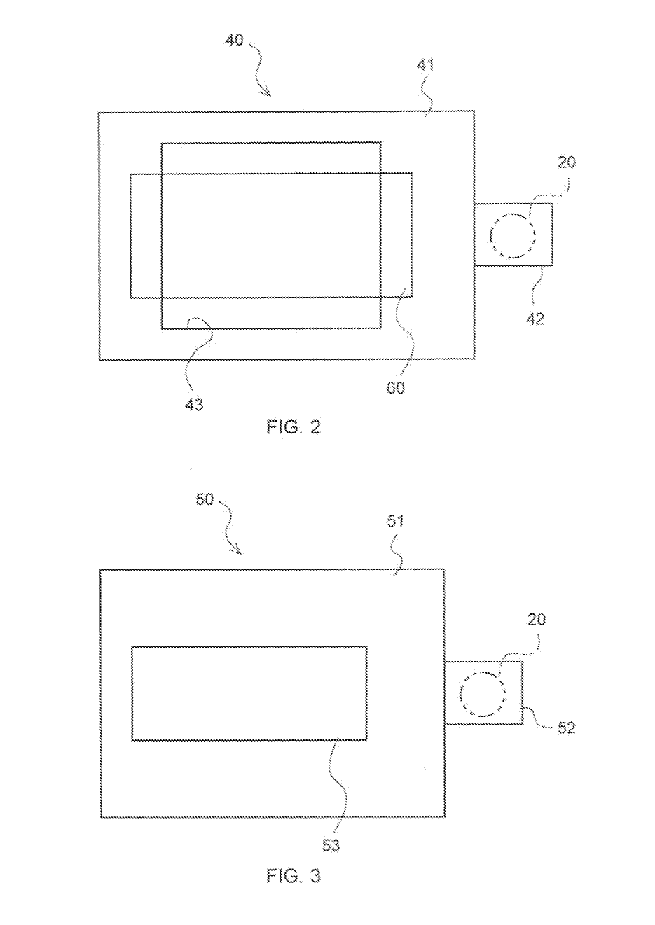

The supporting unit 40 comprises the plate member 41 as described above. FIG. 2 shows a plan view of the supporting unit 40. The plate member 41 is rectangle as shown in the plan view in FIG. 2 and has a rectangular opening 43. The size of the opening 43 are determined in such a manner that appropriate portions of the substrate to be subjected to imaging can be held (in this embodiment, supported from below) along its outer periphery by appropriate portions of the opening along its inner periphery.

The substrate is represented by the reference numeral 60 in FIGS. 1 and 2. As shown in FIG. 2, the inner periphery of the opening 43 can support both ends of the short side of the substrate 60 from below. It should be noted that the opening 43 in the plate member 41 may be provided so that the size thereof can be changed using a known appropriate technique. Moreover, the plate member 41 may have a known appropriate means (such as a dip) to fix the substrate 60 in a removable manner in addition to merely supporting the substrate 60 from below.

The imaging unit 50 comprises the plate member 51 as described above. An imaging element 53 is placed at a predetermined position on the plate member 51. The imaging element 53 may or may not be secured to the plate member 51. In this embodiment, the imaging element 53 is secured to the plate member 51.

The imaging element 53 has a rectangular shape when viewed from above as shown in FIG. 3 which is a plan view of the imaging unit 50. The imaging element 53 may be achieved by, for example, a charge-coupled device (CCD) or a complementary metal oxide semiconductor (CMOS). The imaging element 53 has an imaging plane 53A with a lot of pixels. The imaging plane 53A is on the upper side from the perspective of FIG. 1 and faces the hole 34 serving as a point light source across the substrate 60 when the imaging device 100 is used.

The imaging element 53 is connected to a display which is not shown. An image taken by the imaging element 53 is presented on the display in real time in this embodiment. Although the connection between the display and the imaging element 53 may be achieved via either wireless or wired connection, the latter is used in this embodiment through a cable which is not shown. In addition, the imaging element 53 and the display may be connected directly or indirectly via a predetermined instrument such as a control box. For example, when the display is one for personal computers, the imaging element 53 is connected to a computer itself and the computer is in turn connected to the display. If the images taken by the imaging element 53 are not required to be checked, the imaging element 53 is not necessarily connected to the display. Instead, image data taken by the imaging element 53 may be stored on a predetermined recording medium such as a hard disk drive.

Next, how to use the imaging device 100 is described.

An object whose image is taken by the imaging device 100 is the substrate 60 that allows light to pass through and that carries a small imaging target on or in the surface thereof. More specifically, what is being imaged by the imaging device 100 is a subject present on or in the surface of the substrate 60. The substrate 60 is not necessarily transparent/translucent and a part of it may be opaque. It should have, however, light transmittance to a degree that the illumination light produced by the illumination unit 30 can reach the imaging plane 53A of the imaging element 53 and allow the imaging element 53 to take an image of the subject.

The substrate 60 in this embodiment is a substrate used in biosensor techniques described in the background section of the present specification. The subject whose image is taken is a magnetic microparticle with a size on the order of micrometers. Description of the substrate preparation for imaging is omitted here to avoid redundancy because the procedure is as described in the background section. The magnetic microparticles and the magnetic nanoparticles should remain magnetized to keep their mutual attraction, so that the magnetic microparticles and the magnetic nanoparticles should be exposed to the magnetic field during the imaging by the imaging device 100. In order to achieve this, for example, it is enough to place a magnet on the plate member 41 at a position immediately adjacent to the substrate 60.

When any motion of the surface of the solution containing the magnetic microparticles affects the imaging, a thin cover slip may be placed on the solution.

To take an image of the substrate 60 using the imaging device 100, the substrate 60 is placed on the plate member 41 at a position shown in FIGS. 1 and 2. The relative positions of the illumination unit 30, the supporting unit 40, and the imaging unit 50 are then adjusted. It is noted that the order of these operations (i.e., the adjustment of the relative positions of the illumination unit 30, the supporting unit 40, and the imaging unit 50, and the placement of the substrate 60 on the plate member 41) is not critical.

Next, the lighting member 36 is turned on to make the lighting member 36 emit the illumination light. The illumination light passes through the hole 34 as depicted by dashed-two dotted lines in FIG. 1. As described above, the hole 34 serves as a point light source. The illumination light passed through the hole 34 as the point light source then passes through the substrate 60 and is directed to the imaging element 53 of the imaging unit 50. This illumination light is captured by the imaging plane 53A of the imaging element 53.

In this way, the imaging element 53 takes an image of the subject on or in the substrate 60. Data about the image produced as a result of the image-pickup made by the imaging element 53 are sent to a display which is not shown through a cable which is not shown. The image produced as a result of the image-pickup made by the imaging element 53 is presented on the display in almost real time.

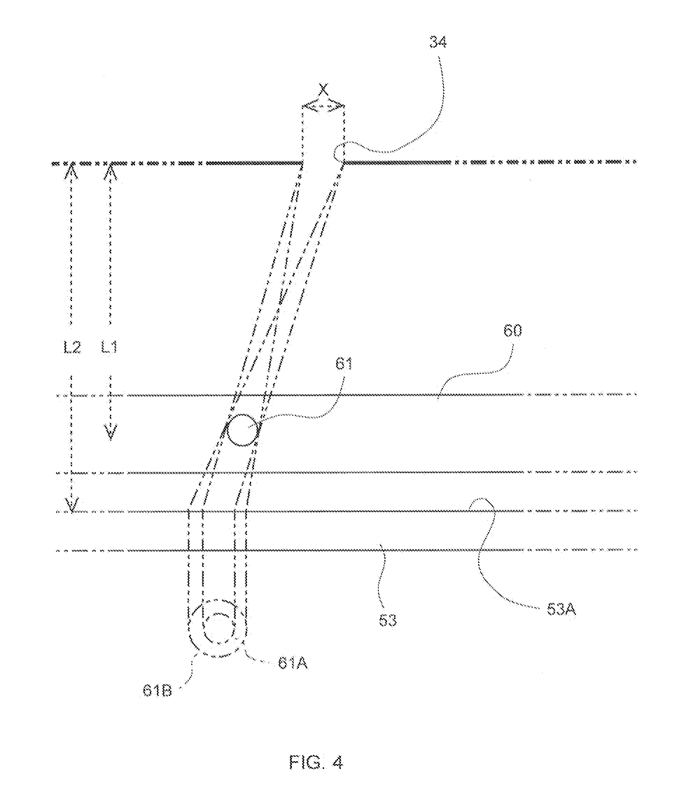

The motion of the illumination light in this case is schematically shown with dashed-two dotted lines in a side view in FIG. 4. The subject in this case is a magnetic microparticle which is depicted by the reference numeral 61.

Only a limited amount of the illumination light passes through the hole 34 having a diameter X and is directed to the substrate 60. This illumination light passes through the substrate 60 and is directed to the imaging plane 53A of the imaging element 53. Let the distance between the hole 34 and the substrate 60 be L1, the distance between the hole 34 and the imaging plane 53A of the imaging element 53 be L2, the optical magnification of this imaging device 100 can be represented as L2/L1. Accordingly, the image of the subject 61 is magnified by L2/L1 fold.

In FIG. 4, two circles 61A and 61B are concentrically shown by dashed-two dotted lines below the imaging element 53. They are images of the subject 61 projected on the imaging plane 53A of the imaging element 53. A circle expected to be between the circle 61A and the circle 61B is enlarged images of the subject, of which size is L2/L1 times larger than the subject 61. The region within the circle 61A is focused on the image taken by the imaging element 53 while the region between the circle 61B and the circle 61A are slightly unfocused on the same image.

A preferable situation is where the circle 61B is large to a certain degree and the circle 61A is as close in size to the circle 61B as possible.

Since the size of the circle 61B (or the circle expected to be between the circle 61A and the circle 61B) is the size of the subject 61 in the image taken by the imaging element 53, it is better that the circle is large to a certain degree if it is desired to know the shape of the subject. In this case, it is preferable that the circle 61B is on more than one (e.g., two or three), and if possible, 9 (3 by 3) or more pixels of the imaging plane 53A. Conditions where the circle 61B is on 3 by 3 or more pixels can be obtained easily when the diameter X of the hole 34, the length L1 between the hole 34 and the substrate 60, the length L2 between the hole 34 and the imaging plane 53A of the imaging element 53, the size of the subject 61 and the size of the pixels on the imaging plane 53A are known previously. Adjustment of the relative positions of the illumination unit 30, the supporting unit 40, and the imaging unit 51) can thus be made in order to satisfy this condition. In this embodiment, after the adjustment to satisfy such conditions, the circle 61B is on 5 by 5 pixels.

If a user only want to know the presence or absence of the subject, the circle 61B is not necessarily on more than one pixel because one pixel of the imaging plane 53A is enough. In this embodiment, it is only necessary to find out, for example, whether the magnetic microparticle is present at a predetermined position, so that the circle 61B is not required to be on more than one pixel of the imaging plane 53A.

In order to make the size of the circle 61A closer to that of the circle 61B, it is necessary that the difference between L1 and L2 is small and the diameter X of the hole 34 is also small. Since L1 and L2 directly affect the magnification as described above, it is important to decrease the diameter X of the hole 34 as small as possible to make the size of the circle 61A closer to that of the circle 61B. This is why the substantial point light source is used for illumination in the imaging device 100 in this embodiment,

### Second Embodiment

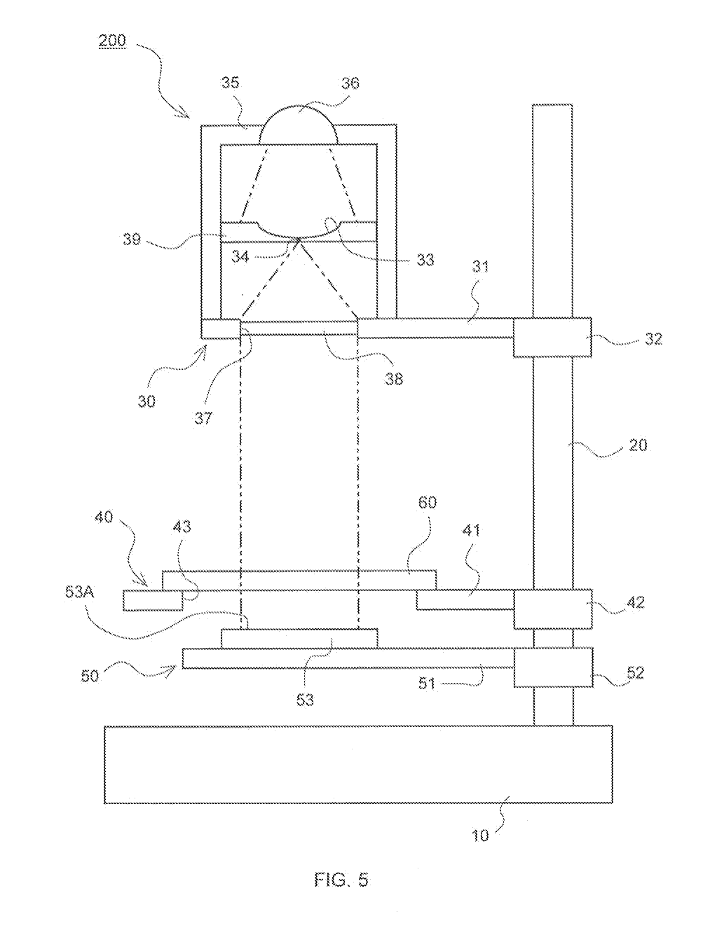

FIG. 5 schematically shows an imaging device 200 according to the second embodiment. This imaging device 200 is also for taking an image of a small subject present on or in the surface of a substrate that allows light to pass through, as in the case of the first embodiment. In the second embodiment, a substrate similar to the one described in the first embodiment is subjected to imaging.

The difference between the imaging device 200 in the second embodiment and the imaging device 100 in the first embodiment substantially lies only in the structure of the illumination unit 30.

As in the case of the first embodiment, the imaging device 200 according to the second embodiment comprises the base 10 and the post 20. Their structures are identical to those in the first embodiment. In addition, the illumination unit 30, the supporting unit 40, and the imaging unit 50 are connected, in this order from above, to the post 20 of the imaging device 200 according to the second embodiment, as in the case of the imaging device 100 according to the first embodiment. The structures of the supporting unit 40 and the imaging unit 50 in the imaging device 200 according to the second embodiment are completely identical to those in the first embodiment. Furthermore, the structure of the post clamp 32 of the illumination unit 30 in the imaging device 200 according to the second embodiment is also completely identical to the one in the first embodiment.

The illumination unit 30 of the second embodiment comprises a plate member 31 whose structure is slightly different from that of the first embodiment. The plate member 31 of the second embodiment has a bore 37 in place of the concave portion 33. A Fresnel lens 38 is fitted therein to collimate light from the point light source located at the focal point of the lens.

The rectangular parallelepiped case 35 is placed on the plate member 31 of the second embodiment as in the case of the first embodiment. The lighting member 36 similar to the one described in the first embodiment is provided in the top of the case 35 of the second embodiment.

An upper plate member 39 is disposed in the case 35 of the second embodiment between the plate member 31 and the lighting member 36. The upper plate member 39 in this embodiment is parallel to the plate member 31. The concave portion 33 is formed in the upper plate member 39 which is similar to the one formed in the plate member 31 of the first embodiment. The hole 34 is formed at the center of the concave portion 33 as the pinhole. The hole 34 is located at the focal point of the Fresnel lens 38.

The light produced by the lighting member 36 reaches the space under the upper plate member 39 in the case 35 only through the hole 34, and escapes from the case 35 only through the Fresnel lens 38.

The hole 34 as a pinhole substantially serves as the point light source located at the focal point of the Fresnel lens 38, on that the light emerge from the Fresnel lens 38 in a parallel beam.

As apparent from the above, the illumination unit 30 of this embodiment directs a parallel beam to the substrate. As long as this can be achieved, the configuration of the illumination unit 30 may be changed. For example, the Fresnel lens 38 may be replaced with a condenser lens.

Next, how to use the imaging device 200 is described.

The way to take an image of the substrate 60 in the imaging device 200 is basically identical to the one described in conjunction with the first embodiment. In order to take an image of the substrate 60 in the imaging device 200, the substrate 60 is placed on the plate member 41. The relative positions of the illumination unit 30, the supporting unit 40, and the imaging unit 50 are then adjusted. As in the case of the first embodiment, the order of these operations (i.e., the adjustment of the relative positions of the illumination unit 30, the supporting unit 40, and the imaging unit 50, and the placement of the substrate 60 on the plate member 41) is not critical.

Next, the lighting member 36 is turned on to make the lighting member 36 emit the illumination light. The illumination light passes through the hole 34 as depicted by dashed-two dotted lines in FIG. 5 and collimated by the Fresnel lens 38 into a parallel beam. The parallel illumination light passes through the substrate 60 and is directed to the imaging element 53 of the imaging unit 50. The illumination light is captured by the imaging plane 53A of the imaging element 53.

In this way, the imaging element 53 takes an image of the subject on or in the substrate 60. Data about the image produced as a result of the image-pickup made by the imaging element 53 are sent to a display which is not shown through a cable which is not shown, as in the case of the first embodiment. The image produced as a result of the image-pickup made by the imaging element 53 is presented on the display in almost real time.

Unlike the first embodiment, the image obtained by the imaging element 53 is at the same size as the subject (i.e., the optical magnification is equal to 1). The image is focused over the entire region unlike the first embodiment where the image has focused and unfocused regions.

It is preferable that the image of the subject is on more than one, and if possible, 9 (3 by 3) or more pixels of the imaging plane 53A if a user want to know the shape of the subject using this imaging device, as in the case of the first embodiment. On the other hand, if a user only want to know the presence or absence of the subject using this imaging device, the image is not necessarily on more than one pixel of the imaging plane 53A.

It is easy to obtain these conditions when the diameter of the subject and the size of the pixels of the imaging plane 53A are known previously. In this embodiment, the imaging element 53 that satisfies such conditions is used for imaging.

1. An imaging device for taking an image of a small subject present on or in the surface of a substrate that allows light to pass through, comprising:
a light source to produce illumination light and an imaging element which is an element to take an image, said light source and said imaging element being opposed to each other across the substrate,
said light source being a point light source, and
said imaging element having an imaging plane where a number of pixels are arranged, the imaging plane being faced to said substrate.

2. An imaging device as claimed in claim 1, wherein said imaging element is placed away from the substrate, so that an image of the subject whose image is to be taken, on the imaging plane is larger than the size of the pixel.

3. An imaging device as claimed in claim 1, comprising supporting means to position and support the substrate at a predetermined position between said light source and said imaging element.

4. An imaging method for taking an image of a small subject present on or in the surface of a substrate that allows light to pass through, comprising the steps of:
positioning the substrate, a light source which is a point light source to produce illumination light, and an imaging element which is an element to take an image, the imaging element having an imaging plane where a number of pixels are arranged, in such a manner that the light source and the imaging element are opposed to each other across the substrate and that the imaging plane is faced to the substrate; and
directing the illumination light from the light source to the imaging element.

5. An imaging device for taking an image of a small subject present on or in the surface of a substrate that allows light to pass through, comprising:
a light source to produce illumination light and an imaging element which is an element to take an image, said light source and said imaging element being opposed to each other across the substrate,
said light source being a directional light source which produces parallel rays, and
said imaging element having an imaging plane where a number of pixels are arranged, the imaging plane being faced to said substrate.

6. An imaging device as claimed in claim 5, wherein said imaging element is configured in such a manner that an image of the subject whose image is to be taken, on the imaging plane is larger than the size of the pixel.

7. An imaging device as claimed in claim 5, comprising supporting means to position and support the substrate at a predetermined position between said light source and said imaging element.

8. An imaging method for taking an image of a small subject present on or in the surface of a substrate that allows light to pass through, comprising the steps of:
positioning the substrate, a light source which is a directional light source to produce parallel rays, and an imaging element which is an element to take an image, the imaging element having an imaging plane where a number of pixels are arranged, in such a manner that the light source and the imaging element are opposed to each other across the substrate and that the imaging plane is faced to the substrate; and
directing the illumination light from the light source to the imaging element.
